(19) United States
(12) Patent Application Publication
(10) Pub. No.: US 2022/0026128 A1
(43) Pub. Date: Jan. 27, 2022

(54) REFRIGERATION APPLIANCE AND METHOD FOR INITIALISING A DEFROSTING OPERATION IN A REFRIGERATION APPLIANCE

(71) Applicant: BSH HAUSGERAETE GMBH, MUENCHEN (DE)

(72) Inventors: TORSTEN ESCHNER, ULM (DE); JOCHEN HAERLEN, KOENIGSBRONN (DE)

(21) Appl. No.: 17/312,081

(22) PCT Filed: Dec. 4, 2019
(86) PCT No.: PCT/EP2019/083595

§ 371 Date: Jun. 9, 2021

(30) Foreign Application Priority Data
Dec. 10, 2018 (DE) 102018221328.3

(51) Int. Cl. F25B 49/02

(52) U.S. Cl. CPC F25B 49/025; F25B 2600/021; F25B 2347/02; F25B 2700/2104; F25B 2600/0253

(57) ABSTRACT

A method initializes a defrosting operation in a refrigeration appliance having a speed-controlled compressor. The method includes the steps of: a) starting up the compressor at a speed set to an initial value, b) adjusting the speed of the compressor in order to prevent a temperature in a storage chamber of the refrigeration appliance from deviating from a target temperature, c) monitoring a deviation between an adjusted speed and the initial value, and d) deciding that defrosting is necessary if the deviation exceeds a limit value.

The present invention relates to a method for initializing a defrosting procedure in a refrigeration appliance, in particular a household refrigeration appliance, as well as to a refrigeration appliance in which the method can be applied.

Since frost that has condensed on an evaporator impairs the transfer of heat from a storage chamber of a refrigeration appliance to the evaporator, in a conventional refrigeration appliance with a compressor that can only switch between a switched-on and switched-off state, the switched-on phases of the compressor become longer and longer as the layer of frost grows thicker. In such a refrigeration appliance, a common method, e.g. described in KR 20010037545, is to decide the need for a defrosting procedure, to monitor the cumulative runtime of the compressor and the number of door openings since the last defrosting, and to start a defrosting procedure when a predefined limit value is exceeded.

Modern refrigeration appliances use multiple compressors, the rotational speed of which can be set to a plurality of non-vanishing values, also referred to as variable speed compressors in the following. In these refrigeration appliances, the conventional approach described above is unsatisfactory, because as the rate of frost buildup on the evaporator depends upon the rotational speed, it is no longer possible to make an assessment on the basis of the cumulative compressor runtime. U.S. Pat. No. 6,047,554 proposes, in such a case, to ascertain a weighted cumulative runtime, in which operating times with different rotational speeds are included with different weighting. Here, however, a prerequisite for a confident assessment of the frost thickness is that the relationship between compressor rotational speed and rate of frost buildup is known and can be reproduced.

An object of the present invention is to specify a method for initializing a defrosting procedure, which is simple to apply, allows a reliable estimation of the frost thickness and is suitable for a refrigeration appliance with variable speed compressor.

The object is achieved by a method with the steps of

a) starting up the compressor with a rotational speed set to an initial value n₀,

b) adapting the rotational speed nₜ of the compressor, in order to prevent the temperature of a storage chamber of the refrigeration appliance from drifting from a setpoint temperature,

c) monitoring a deviation between the adapted rotational speed nₜ and the initial value n₀, and

d) deciding that a defrosting is necessary when the deviation exceeds a limit value.

The adapting of the rotational speed is typically a continuous procedure, in which the rotational speed in each case is switched between a value that lies slightly above an ideal value which corresponds to the refrigeration requirement of the device but cannot be exactly achieved, and a value that lies slightly above said value, whenever a limit temperature is reached.

Apart from brief interruptions due to the opening of a door of the storage chamber or the inserting of goods to be refrigerated, the temperature of which deviates from the temperature of the storage chamber, the rotational speed of the compressor should substantially depend upon the temperature difference between storage chamber and surrounding environment. A systematic deviation of the rotational speed can then be traced to a transfer of heat between storage chamber and frost impairing the compressor, meaning that when this deviation exceeds a limit value it can be inferred that the layer of frost is thick enough to necessitate a defrosting.

In the simplest case, the deviation can be the current difference between the adapted rotational speed nₜ and the initial value n₀; it is preferred, however, if previously measured differences also have an influence on the instantaneous value of the deviation. As a result, the deviation can then also change if the difference between adapted rotational speed nₜ and the initial value n₀ is constant, but different from zero.

The monitoring of the deviation should in particular comprise at least increasing the deviation, if the adapted rotational speed nₜ lies above the initial value n₀, meaning that, if the compressor runs continuously with a rotational speed above the initial value, the limit value has to be exceeded sooner or later.

In order to be able to account for brief interruptions more effectively, it should also be possible to reduce the deviation again in times in which the adapted rotational speed nₜ lies below the initial value n₀.

A preferred possibility for this is to ascertain the deviation as a time integral of the difference (nₜ−n₀) between the adapted rotational speed nₜ and the initial value n₀. This integral can be formed over the entire runtime of the compressor since the last defrosting procedure. It is also conceivable, however, to exclude certain time periods from the formation of the integral, e.g. those in which the deviation is negative or lies between zero and a small negative limit value. In this way, it can be ensured that the deviation then also has a tendency to increase over time and leads to the start of a defrosting procedure when the adapted rotational speed nₜ does not significantly deviate from the initial value n₀.

The adapting of the rotational speed of the compressor in step b) expediently comprises a lowering of the rotational speed nₜ in the event of falling below a first limit temperature of the storage chamber, and raising the rotational speed nₜ in the event of exceeding a second limit temperature of the storage chamber. The raising and lowering can take place continuously or in the form of discrete steps.

The initial value n₀ can be ascertained empirically in the course of the method in each case. In particular, in each starting phase of the operation after a defrosting procedure, a rotational speed can be ascertained that proves to be suitable for maintaining the setpoint temperature in the storage chamber of the refrigeration appliance, and the initial value n₀ can be derived from said rotational speed.

In the simplest case, the deriving consists in the ascertained suitable rotational speed being adopted as the initial value n₀ in an identical manner.

Assuming that the temperature of the surrounding environment, in which the refrigeration appliance is placed, does not significantly change in the course of a plurality of defrosting cycles, the initial value n₀ may also be formed by an average value of the suitable rotational speed ascertained after the last defrosting procedure and the suitable rotational speeds ascertained after one or more earlier defrosting procedures.

Moreover, it is conceivable to reduce the ascertained suitable rotational speed by a predefined amount and to adopt the result as initial value n0, in order to in this way ensure that the deviation grows over time and thus a defrosting procedure is triggered with certainty, or—with the same result—to choose the limit value as a decreasing function of the compressor runtime since the last defrosting procedure.

Alternatively, the initial value n₀ may be predefined as a function of the ambient temperature. In order to detect this, a refrigeration appliance, in which the method according to the invention is applied, should be equipped with an ambient temperature sensor.

In the simplest case, the ambient temperature measured at the end of a defrosting procedure is used as an argument of the function; the initial value n₀ then remains unchanged until the next defrosting procedure.

One advantage of the alternative, however, is that the initial value n₀ can also be a function of the instantaneous ambient temperature, i.e. variable between two defrosting procedures. It can thus be avoided that an increase in the compressor rotational speed nₜ, traced back to a rise in the ambient temperature, is misinterpreted as evidence of a pronounced frost buildup and leads to a premature defrosting.

In order to ensure that a defrosting procedure is also triggered sooner or later if the compressor rotational speed nₜ stays the same on average, it is furthermore possible to choose the limit value as a decreasing function of the compressor runtime since the last defrosting procedure.

A further subject matter of the invention is a refrigeration appliance, in particular a household refrigeration appliance, with at least one storage chamber, a variable speed compressor for cooling the storage chamber, and a control unit for regulating the rotational speed of the compressor on the basis of a temperature measured in the storage chamber, which is configured and in particular is programmed to carry out the method described above.

A further subject matter of the invention is a computer program product with program code means that enable a computer to carry out the method described above or to operate as a control unit in the refrigeration appliance described above. In particular, the computer program product can be present as memory content of a microprocessor system or, in a form detached from the microprocessor system, on a data carrier.

Further features and advantages of the invention will emerge from the description of exemplary embodiments provided below, with reference to the attached drawings, in which:

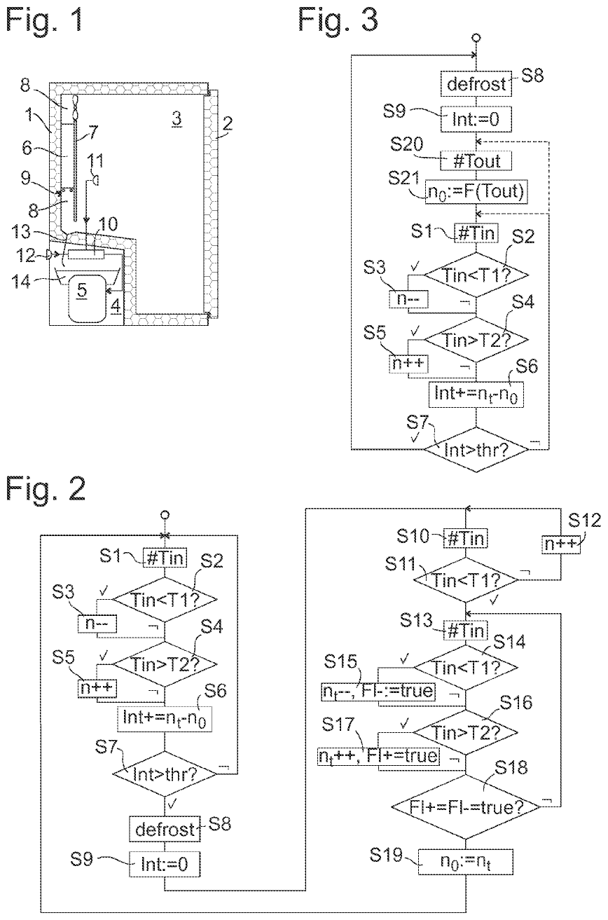

FIG. 1 shows a refrigeration appliance in accordance with the present invention in schematic form;

FIG. 2 shows a flow diagram of a method in accordance with a first embodiment of the invention; and

FIG. 3 shows a flow diagram of a method in accordance with a second embodiment of the invention

FIG. 1 shows a schematic section through a household refrigeration appliance of a construction which is known per se. A thermally insulating carcass 1 and at least one door 2 delimit at least one storage chamber 3. Accommodated in a machine room 4 of the carcass 1 is a variable speed compressor 5, which is connected to a condenser (not shown), a choke point and at least one evaporator 6 in a coolant circuit and supplies the evaporator 6 with liquid coolant to cool the storage chamber 3.

Here, the evaporator 6 is shown as a no-frost evaporator in an evaporator chamber 8 separated from the storage chamber by an intermediate wall 7. Here, a defrost heater 9 can be formed by a heating rod, which is mounted on an underside of the block-shaped evaporator 6 and heats said evaporator by physical contact, radiation and/or convection during defrosting. A passage 13 is provided at the bottom of the evaporator chamber 8, in order to drain condensation water from the evaporator 6 to the outside, typically into an evaporation pan 14 in the machine compartment 4.

A control circuit 10, typically a microprocessor system that controls the operation of the compressor 5 and the defrost heater 9, can be placed at any suitable place on the carcass 1. The control circuit 10 is connected to an internal temperature sensor 11 for detecting the temperature of the storage chamber 3; furthermore, an ambient temperature sensor 12 for detecting the ambient temperature can be connected to the control circuit 10.

FIG. 2 shows an operating method for the control circuit 10 in accordance with a first embodiment of the invention. This operating method does not require the ambient temperature sensor 12.

During normal operation, the control circuit 10 runs through a loop at regular time intervals, of which the first step S1, in the representation in FIG. 2, is the detection of the internal temperature Tin with the aid of the temperature sensor 11. This internal temperature Tin should be kept close to a setpoint temperature set on the control circuit 10 by the user. To this end, in step S2 the control circuit 10 compares the internal temperature Tin with a first limit temperature T1, which may be identical to the setpoint temperature, but preferably is a few degrees lower. In the event of falling below the limit temperature T1, then this indicates that the instantaneous rotational speed nₜ of the compressor 5 is higher than required to maintain the setpoint temperature; for this reason, in this case, the rotational speed nₜ is decremented (S3) by a predefined step size.

In step S4, the internal temperature Tin is compared with a second limit temperature T2, and in the event of T2 being exceeded, the rotational speed nₜ is decremented in step S5. The step sizes can be the same in step S3 and S5, but do not have to be. Likewise, the second setpoint temperature T2 can be identical to the setpoint temperature, but typically lies slightly higher, so that T1 and T2 define a temperature interval of a few degrees wide, within which the rotational speed nₜ is not changed.

In step S6, the difference between the instantaneous rotational speed nₜ of the compressor 5 and an initial value n₀ is added to a control variable Int. Since, as the thickness of a layer of frost on the evaporator 6 increases, the compressor rotational speed needed to keep the storage chamber 3 at the setpoint temperature rises, this difference tends to assume values that are all the more positive, the longer it has been since the last defrosting procedure, meaning that the control variable Int rises over time.

As long as it is determined in step S7 that the control variable Int has not yet exceeded a threshold value thr, the method returns to the beginning, and the loop of steps S1 to S6 is repeated.

By contrast, if the threshold thr is exceeded, then the control circuit 10 switches off the defrost heater 9 and the compressor 5, in order to defrost (S8) the evaporator 6.

Following successful defrosting, the control variable Int is reset (S9) to a starting value that is lower than thr, typically to zero, and the compressor 5 is returned to operation.

The rotational speed when resuming operation can be a fixed standard value; it is also conceivable to resume operation with the rotational speed at which it was canceled in order to perform the defrosting. In the latter case, the rotational speed is usually higher than required to keep the storage chamber 3 at the setpoint temperature during continuous operation; however, this is also expedient in order to remove the heat, which has entered during the defrosting, from the storage chamber 3 again in a short period of time.

The temperature Tin of the storage chamber 3 is measured in step S10 and then compared with T1 in step S11. Due to the preceding interruption of the cooling operation and the unavoidable ingress of heat due to the defrosting, the temperature Tin will lie above T1 immediately after the resumption of the operation of the compressor, meaning that the steps S10, S11 are repeated until T1 is exceeded. If, as described above, the restart rotational speed of the compressor 5 has with certainty been chosen to be higher than necessary for maintaining the setpoint temperature, then it is sufficient to repeat the steps S10, S11; otherwise, it can be provided that the rotational speed is increased (S12) incrementally for as long as T1 has not yet been reached. In either case, at the point in time at which Tin falls below T1, the rotational speed nₜ is higher than necessary for maintaining the setpoint temperature.

Furthermore, the temperature Tin is also measured (S13) after falling below T1, and is compared (S14) with T1. If it remains below T1, then each time step S15 is repeated the rotational speed nₜ of the compressor 5 is decremented; additionally, a flag Fl− is set in order to indicate that T1 has been fallen below after restarting the compressor 5.

The consequence of decrementing the rotational speed nₜ is that T2 is exceeded again, sooner or later. As soon as this is identified in step S16, a second flag Fl+ is set (S17) in order to indicate the exceeding, and the rotational speed nₜ is incremented again. As soon as it is identified in step S18 that both flags Fl−, Fl+ are set, the loop of steps S13-S8 is canceled.

The rotational speed nₜ set at this point in time is specified as initial value n₀ in step S19, after which the method returns to normal operation, i.e. the loop of step S1 to S7.

Since, in this way, a slightly lower value is chosen for n₀ than is necessary to maintain the setpoint temperature, the difference nₜ−n₀ is more often positive than negative during normal operation. This ensures that the control variable Int rises in the long term, and that sooner or later a new defrosting procedure is triggered. The faster that frost builds up on the evaporator 6, and for this reason the rotational speed nₜ is raised, the faster that the variable Int rises, and the faster that defrosting takes place once more.

FIG. 3 shows a flow diagram of an operating method in accordance with a second embodiment of the invention. The representation of the method begins here with a step of defrosting the evaporator 6. This step is identical to the step S8 of the method from FIG. 2, and for this reason is also referred to as S8. The subsequent step S9 of resetting the control variable Int is also identical.

This is followed by a step S20 of measuring the ambient temperature Tout with the aid of the sensor 12. A function F, which assigns a rotational speed of the compressor 5 to a measured ambient temperature Tout in each case, is stored in the control unit 10 in the form of a lookup table or a calculation rule. On the basis of this function F and the measured temperature Tout, an appropriate initial value n₀ for the rotational speed when restarting the compressor 5 after the defrosting is specified in step S21. The function F can be defined such that it assigns each value of the ambient temperature Tout precisely the rotational speed that would be produced in stationary operation with a frost-free evaporator 6 for the ambient temperature in question when the steps S1-S5 described above are carried out repeatedly; in this case the compressor could theoretically run for any given length of time without defrosting, if the door 2 is not opened and also no moisture enters the storage chamber 3 in other ways that could condense as frost on the evaporator.

It is also conceivable, however, as described above in connection with FIG. 2, to choose the values of F to be slightly smaller in each case, in order thus to ensure that defrosting occurs after a finite runtime of the compressor 5, even without the rotational speed nₜ rising over time.

The same effect could also be achieved by the threshold value thr being reduced in a time-dependent manner, e.g. by a step of decrementing thr being added into the loop S1-S7.

After specifying the initial value n₀, the temperature Tin of the storage chamber 3 is detected; this step is identical to the step S1 from FIG. 2 and therefore is also referred to as S1. The following steps S2-S7 are also the same as in FIG. 2 and are therefore not described once more here. If it emerges in step S7 that the control variable Int has exceeded the threshold value thr, then the method branches out to S8, in order to defrost the evaporator 6.

If the threshold value thr has not yet been reached in step S7, then a first variant of the method returns to step S1, in order once again to measure the temperature Tin, so that after repeatedly running through the loop S1-S7 the control variable Int approximates the integral

$$\int {n}_{t} - {n}_{0} dt$$

where n₀=F(Tout(t₀)), i.e. is the value of F that corresponds to the temperature Tout at the point in time to of restarting operation of the compressor.

If the ambient temperature decreases or increases during an operating phase of the compressor 5, then this leads to a reduction or increase in the rotational speed nₜ over steps S2 or S4. A reduction would have the consequence that the control variable Int rises more slowly than if the ambient temperature were to remain the same, and that consequently a defrosting procedure is delayed, even if the frost on the evaporator 6 has already reached a thickness at which it would make sense to perform a defrosting; conversely, an increase in the ambient temperature can trigger a premature defrosting. In order to avoid this, if the threshold value thr has not yet been reached in step S7, according to a second variant, the method jumps back to step S21, i.e. the ambient temperature Tout is measured, and n₀ is updated on the basis of the measured temperature: n₀(t)=F(Tout(t)), where t is the current point in time in each case. In this way, the time period between two defrosting procedures can be made independent of fluctuations in the ambient temperature Tout.

### REFERENCE CHARACTERS

1 carcass
2 door
3 storage chamber
4 machine compartment
5 compressor
6 evaporator
7 intermediate wall
8 evaporator chamber
9 defrost heater
10 control circuit
11 internal temperature sensor
12 ambient temperature sensor
13 passage
14 evaporation pan

1-11. (canceled)

12. A method for initializing a defrosting procedure in a refrigeration appliance with a variable speed compressor, which comprises the steps of:
a) starting up the variable speed compressor with a rotational speed nₜ set to an initial value n₀;
b) adapting the rotational speed nₜ of the variable speed compressor, in order to prevent a temperature of a storage chamber of the refrigeration appliance from drifting from a setpoint temperature;
c) monitoring a deviation between an adapted rotational speed nₜ and the initial value n₀; and
d) deciding that defrosting is necessary when the deviation exceeds a limit value.

13. The method according to claim 12, wherein the monitoring includes increasing the deviation, if the adapted rotational speed nₜ lies above the initial value n₀.

14. The method according to claim 12, wherein the monitoring includes reducing the deviation, if the adapted rotational speed nₜ lies below the initial value n₀.

15. The method according to claim 12, which further comprises ascertaining the deviation as a time integral of a difference between the adapted rotational speed nₜ and the initial value n₀ or the time integral of the difference of one of a plurality of terms that are summed to form the deviation.

16. The method according to claim 12, wherein the adapting of the rotational speed nₜ of the variable speed compressor in step b) includes a lowering of the rotational speed nₜ in an event of falling below a first limit temperature of the storage chamber, and raising the rotational speed nₜ in an event of exceeding a second limit temperature of the storage chamber.

17. The method according to claim 12, wherein in step a), ascertaining the rotational speed which, in a starting phase of an operation after the defrosting procedure, proves to be suitable for preventing the temperature in the storage chamber of the refrigeration appliance from drifting from the setpoint temperature, and the initial value n₀ is derived from a suitable rotational speed.

18. The method according to claim 12, wherein the initial value n₀ is predefined as a function of an ambient temperature.

19. The method according to claim 18, wherein the initial value n₀ is a function of an instantaneous ambient temperature.

20. The method according to claim 18, wherein the limit value is a decreasing function of a compressor runtime since a last defrosting procedure.

21. A refrigeration appliance, comprising:
at least one storage chamber;
a variable-speed compressor for cooling said at least one storage chamber; and
a controller for regulating a rotational speed of said variable speed compressor on a basis of a temperature measured in said at least one storage chamber, said controller configured to initializing a defrosting procedure in the refrigeration appliance by said controller being programmed to:
a) start up said variable speed compressor with the rotational speed nₜ set to an initial value n₀;
b) adapt the rotational speed nₜ of said variable speed compressor, in order to prevent the temperature of said at least one storage chamber of the refrigeration appliance from drifting from a setpoint temperature;
c) monitor a deviation between an adapted rotational speed nₜ and the initial value n₀; and
d) decide that defrosting is necessary when the deviation exceeds a limit value.

22. The refrigeration appliance according to claim 21, wherein the refrigeration appliance is a household refrigeration appliance.

23. A non-transitory computer readable medium having computer readable instructions that enable a computer to carry out a method for initializing a defrosting procedure in a refrigeration appliance with a variable speed compressor, which comprises the steps of:
a) starting up the variable speed compressor with a rotational speed nₜ set to an initial value n₀;
b) adapting the rotational speed nₜ of the variable speed compressor, in order to prevent a temperature of a storage chamber of the refrigeration appliance from drifting from a setpoint temperature;
c) monitoring a deviation between an adapted rotational speed nₜ and the initial value n₀; and
d) deciding that defrosting is necessary when the deviation exceeds a limit value.
